(19) United States
(12) Patent Application Publication
(10) Pub. No.: US 2025/0173614 A1
(43) Pub. Date: May 29, 2025

(54) Entity Graph Having Bidirectionally Traversable and Multi-Semantic Relationships Between Entities in a Digital Twin

(71) Applicant: Twinit Limited, Dublin (IE)

(72) Inventors: Amogh Anil Chitnis, Brisbane (AU); Anand Mecheri, Dublin (IE)

(21) Appl. No.: 18/894,499

(22) Filed: Sep. 24, 2024

Related U.S. Application Data
(60) Provisional application No. 63/603,751, filed on Nov. 29, 2023.

(51) Int. Cl. G06N 20/00

(52) U.S. Cl. CPC G06N 20/00

(57) ABSTRACT

According to aspects of the disclosed subject matter, a digital twin controller, as implemented on a computer system, is presented. With respect to the represented system, the digital twin controller utilizes an entity graph that includes one or more bidirectional, multi-semantic relationships between the graph nodes. Advantageously, the resources to store the entity graph having bidirectional, multi-semantic relationships is reduced. Similarly, this updated entity graph provides for more efficient processing.

### REFERENCE TO RELATED APPLICATIONS

This application claims priority to U.S. Provisional Patent Application No. 63/603,751, entitled “Method for Creating Bi-Directionally Traversable and Multi-Semantic Relationships Between Entities in a Digital Twin,” filed Nov. 29, 2023, the entirety of which is incorporated herein by reference.

### BACKGROUND OF THE INVENTION

A “digital twin” is a virtual, digital model of an actual (often physical) product, system, structure or process. The modeled system is also referred to as the actual or “physical twin” to the digital twin. By way of illustration and not limitation, a digital twin may correspond to a building (the physical twin) that has an HVAC system, a lighting system, elevators, a security system, and the like, where the building itself is represented as node in the digital model, each subsystem is represented as sub-nodes of the building, and each sub-node (sub-system) is further represented as a node in the digital model. As another illustrative example, a digital twin may correspond to a system comprising set of digital processes (a virtual twin) operating in the cloud that monitor digital currencies and digital currency exchanges, where the digital processes interact with third-party data and services. As a simpler illustrative example, a home automation system of a person's home (a physical twin) may be implemented as a digital twin. As can be seen from these examples, a digital twin may correspond from simple to highly complex real-world entities.

Often, a digital twin is very detailed and can be dynamic, including adding, modifying and/or removing entities represented as nodes in the digital model, especially when the digital twin models/corresponds to a dynamically changing system.

The complexity of a digital twin is use-case driven and each implementation varies from others in sophistication. They can be descriptive of a corresponding entity, informative, predictive, prescriptive and/or transformative. Digital twins can be discrete or composite. A discrete Digital Twin involves creating a digital representation of discrete components within a system or a process. In contrast, composite digital twins may include the integration of multiple discrete digital twins in a single digital twin model to provide a holistic view of an entire system or a process, where the modeled “thing” includes may sub-processes or sub-systems.

Using digital twins, one may leverage the power of data, data models, integration, IoT (Internet of Things), analytics, simulation, and visualization for a variety of purposes to optimize processes and/or enhance business value. Advantageously, digital twins can be used to improve decision-making, efficiency, agility, productivity, health and safety, collaboration, stakeholder engagement, and the like, all leading to increased profitability and enhanced performance, while driving sustainability by reducing use of energy, water and waste.

A core feature of a digital twin is its digital model of the “thing” or “system,” represented as a digital graph. The digital graph represents the various elements (referred to as “entities”) of the system as entity nodes in the digital graph. Each entity node represents the behaviors of the corresponding entity (including past, present and predicted future behaviors), with other entities, descriptive features and properties, as well as their related data and documents. Integrations with real time data sources and other applications are another key part of a digital twin, and such integrations are also represented within the digital model.

In a digital twin, the interconnectedness of the modeled system's entities is achieved by defining relationships between those entities. Current implementations of digital twin systems model relationships as a set of unidirectional (from one entity to another) relationships, each unidirectional relationship having a single semantic context, and further provides a unidirectional traversal from a parent entity node to a child entity node. In the event that an inverse traversal of the relationship between the same entities is available, a similar but separate unidirectional relationship is defined for the reverse traversal utilizing the same semantic context. Indeed, in some implementations that claim bi-directional relationships, in fact they are simply pairs of unidirectional relationships. Ultimately, current digital twin systems must maintain two separate relationships within the digital model to illustrate a real-world bi-directional relationship between the two nodes for the same semantic context.

Still further, current digital twin implementations combine a unidirectional relationship (or pairs of unidirectional relationships to simulate bidirectionality) with a single semantic context. That, however, doesn't reflect the fact that two entities can, and often do, share relationships over multiple semantic contexts. Consequently, current digital twin implementations require two relationships (to simulate bidirectionality) for each semantic context a pair of entities share. Clearly, current implementations of digital twins suffer significant inefficiencies in the storage, maintenance, and processing of digital models.

### SUMMARY OF THE INVENTION

According to aspects of the disclosed subject matter, a digital twin controller is presented, as implemented on a computer system. With respect to the represented computer-implemented system, the digital twin controller utilizes an entity graph that includes one or more bidirectional, multi-semantic or bidirectional and multi-semantic relationships between the graph nodes. Advantageously, the resources to store the entity graph, particularly its relationship table, having bidirectional, multi-semantic relationships is reduced. Similarly, this updated entity graph provides for more efficient processing.

In accordance with additional aspects and embodiments of the disclosed subject matter, the digital twin controller is further enabled to link to external resources, i.e., external to the physical twin/modeled system, for data or services that may be useful in the maintenance and operation of the physical twin. Indeed, in some embodiments, when access to external service (external to the physical twin) is desired, the digital twin controller can utilize a virtual entity node incorporated into the entity graph, where the virtual entity node serves as an interface for an external resource (external to the physical twin). In various embodiments, relationships between entity nodes in the entity graph (corresponding to elements of the modeled system) and the virtual entity node may be bidirectional and, if appropriate, multi-semantic. In various embodiments, this “extension” of the entity graph to include the virtual entity node becomes a part of the entity graph, while in alternative embodiments, the link via a virtual entity node is implemented as a transient, in-the moment extension for a temporary purpose of accessing an external resource.

In accordance with additional aspects and embodiments of the disclosed subject matter, the entity graph provides a feature that enables the digital twin controller to link to external resources for data or services based on a desired attribute of an external resource. In accordance with aspects of the disclosed subject matter, in response to a request for data or services having a particular attribute, the digital twin controller identifies an external source from a data set of external sources that provides a resource corresponding to the desired attribute. The digital twin controller then identifies an entity node within the entity graph that includes an attribute module corresponding to the desired attribute. A virtual entity node is established by the digital twin controller for interacting with the identified data resource. The digital twin controller links the identified entity node and the virtual entity node, such that they can interact. The virtual entity node is configured to interact with the external resource and with an entity node in the entity graph. Subsequently, a request for data from the external resource is routed to the identified entity node which interacts, via the attribute model, with the virtual entity node which, in turn, interacts with the external resource. In various embodiments, instantiation of the virtual node to the external data source may occur in a just-in-time manner. Moreover, no formal relationship between identified entity node and the virtual node is stored in the entity graph or the relationship table.

In accordance with further aspects and embodiments of the disclosed subject matter, the entity graph provides a feature that enables the digital twin controller to link to a specific, external resource. In accordance with aspects of the disclosed subject matter, in response to a request for data or services from an external resource (to the physical twin), the digital twin controller identifies the external resource from a set of links to external resources. The digital twin controller then identifies an entity node (the identified entity node) within the entity graph that will act as if the external resource, particular the services and/or data of the external resource, is available from that entity node. A link module for inter-connecting with the selected external resource via a virtual entity node, is incorporated in or is a part of the identified entity node. A virtual entity node, suitably configured to interact with the external resource identified by the link, and further suitable configured to interact with the identified entity node, is also established. Once established, the digital twin controller can call on the identified entity node for that service (i.e., the external data resource) as if it were a part of the identified entity node. As with attributes, in various embodiments, instantiation of the virtual entity node to link to the external data source may occur in a just-in-time manner. Moreover, no formal relationship between the identified entity node and the virtual node is stored in the entity graph.

### BRIEF DESCRIPTION OF THE FIGURES

The foregoing aspects and many of the attendant advantages of the disclosed subject matter will become more readily appreciated as they are better understood by reference to the following description when taken in conjunction with the following drawings, wherein:

FIG. 1A is a pictorial diagram illustrating an entity graph of entity nodes having only unidirectional, single semantic relationships, and FIG. 1B is a block diagram illustrating an exemplary relationship table of the entity graph of FIG. 1A;

FIG. 2A is a pictorial representation of the entity graph of FIG. 1 as adapted, according to aspects of the disclosed subject matter to include bidirectional and/or multi-semantic relationships among entity nodes, and FIG. 2B is a block diagram illustrating an exemplary relationship table of the entity graph of FIG. 2A;

FIG. 3A is a pictorial representation of an entity graph that extends of the entity graph of FIG. 2A according to aspects of the disclosed subject matter, to include a virtual entity node for accessing an external resource, and FIG. 3B is a block diagram illustrating an exemplary relationship table of the entity graph of FIG. 3A;

FIG. 4A is a pictorial representation of an alternative entity graph of FIG. 3A, that includes a virtual entity node for accessing an eternal resource, and FIG. 4B is a block diagram illustrating an exemplary relationship table of the entity graph of FIG. 4A;

FIG. 5 is a pictorial diagram of an entity graph adapted from the entity graph of FIG. 4A, where access to the external resource is driven based on desired attribute of the external resource, in accordance with aspects of the disclosed subject matter;

FIG. 6 is a pictorial diagram of an entity graph adapted from the entity graph of FIG. 4A, where access to the external resource is driven based on link to the external resource, in accordance with aspects of the disclosed subject matter;

FIG. 7 is a flow diagram illustrating an exemplary routine for converting an entity graph consisting of unidirectional, single semantic context relationships into an entity graph comprising at least one of a bi-directional and a multi-semantic relationship between nodes in the entity graph, all in accordance with aspects of the disclosed subject matter;

FIG. 8 is a flow diagram illustrating an exemplary routine for executing by a digital controller an action on an element of a physical twin through a digital twin's entity graph, in accordance with aspects of the disclosed subject matter;

FIG. 9 is a flow diagram illustrating an exemplary routine for accessing an external resource to a physical twin via the use of a virtual entity node, all in accordance with aspects of the disclosed subject matter;

FIG. 10 is a flow diagram illustrating an exemplary routine for accessing an external resource to a physical twin based on a desired attribute of the external resource, via the use of a virtual entity node, all in accordance with aspects of the disclosed subject matter;

FIG. 11 is a flow diagram illustrating an exemplary routine for accessing an external resource to a physical twin utilizing a link to the external resource, via the use of a virtual entity node, all in accordance with aspects of the disclosed subject matter;

FIG. 12 is a block diagram illustrating an exemplary logical organization of computer-readable medium that bears computer executable instructions for carrying out one or more aspects of the disclosed subject matter; and

FIG. 13 is a block diagram illustrating exemplary and/or logical components of a digital twin controller implemented by a computer system in accordance with aspects of the disclosed subject matter.

### DETAILED DESCRIPTION

In interacting with an entity graph of a digital twin, a digital twin controller (as executed on a computer or computer system) typically, though not exclusively, interacts with the entity graph, and particularly via one or more entity nodes. Through this interaction, and the configuration of the entity nodes to interact with a corresponding element of the physical twin, the digital twin controller manages and interacts with elements of the physical twin. As an example, and to illustrate the use of digital twin controller and the entity graph, assume that a modeled entity (i.e., the physical twin) corresponds to a data center farm, the data center farm comprising a plurality of data center units, where the data center units are organized into clusters. Each cluster has, among many other systems and subsystems including computers, network functionality, power management, and the like. Additionally, assume each cluster includes a central HVAC (heating, venting and air-conditioning) system feeding a smaller HVAC unit of each data center cell in the cluster. Many, if not all of these various “elements” may be managed by the digital twin controller via an entity node specifically configured to interact with some element of the modeled data center farm.

A digital twin controller, typically at the direction of users/managers, manages, monitors, and/or controls the data center farm, including various elements of the data center farm, such as data center cells, power systems, HVAC systems, networking systems, and the like, through interaction with their corresponding entity nodes in the entity graph (the digital twin). With this in mind, assume that a warning of a temperature monitor in a data center cell has triggered an alarm. This alarm is detected by an entity node monitoring for such instances and upon detecting the alarm, reports that alarm up through the entity graph to a point where it is reported to the digital twin controller. Indeed, reporting may involve the traversal of multiple entity nodes to a root entity node that interacts with the digital twin controller. In this example, an operator monitoring the digital twin controller detects the alarm and issues a request to the entity graph to determine the condition of the HVAC unit of the data center cell where the alarm was triggered. Traversal to an entity node associated with the HVAC unit of the data center cell where the alarm was triggered is made, and the “HVAC” entity node is queried for status/condition information. The “HVAC” entity node, in turn, interacts with the HVAC unit of the data center cell to obtain the requested information, and this information is then returned to the “HVAC” entity node, and then through the entity graph to the root entity node where it is reported to the digital twin controller. The operator/manager may then take additional action, as needed, based on the information that was acquired.

While simple, the above example illustrates how the digital twin controller, in interacting with the entity graph representing the digital twin of the physical twin, can manage, maintain, and/or monitor the modeled system. Further, while the above example illustrates a digital twin of a physical, tangible structure, it should be appreciated that a digital twin may correspond to an abstract/online structure (where the modeled system is still referred to as the “physical twin”). For example, a digital twin may be constructed to model a digital currency environment, including ledgers, reserves, mining, and the like, with entity nodes corresponding to specific features and/or services, as well as their constituent elements that are both abstract constructs and physical/tangible constructs.

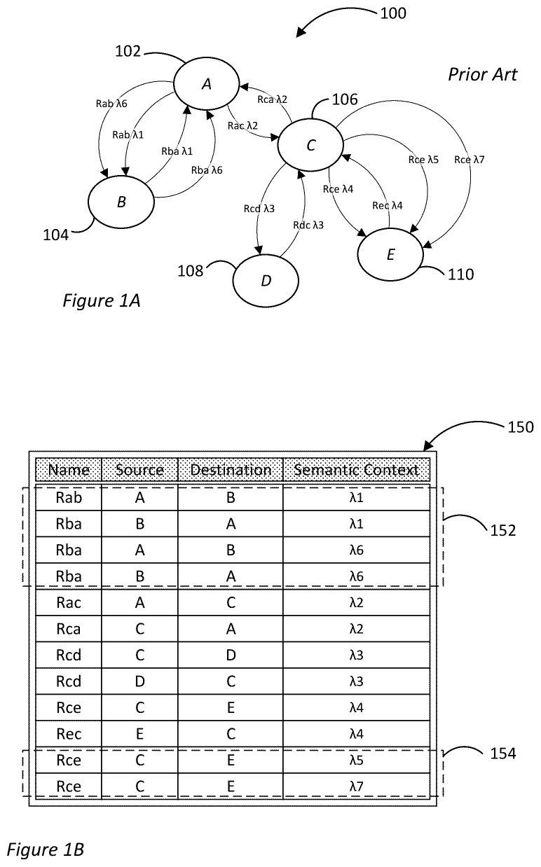

Turning now to FIGS. 1A and 1B, as mentioned above, FIG. 1A is pictorial diagram illustrating an entity graph 100 of entity nodes having only unidirectional, single semantic relationships, while FIG. 1B is a block diagram illustrating an exemplary relationship table of the entity graph of FIG. 1A. As shown in FIG. 1A, the entity graph 100 includes entity nodes 102-110, where entity node A 102 is viewed as the root entity node of the entity graph.

Regarding entity graphs, as can be seen in FIG. 1A, entity nodes in the entity graph 100 have a structured, hierarchical arrangement, where “upper” entity nodes represent larger elements of the physical twin (e.g., an entire data center at the root level), and with subordinate entity nodes, i.e., further away from the root entity node, representing subsystems or sub-elements of the physical twin. An entity node immediately above another entity node (in the direction of the root entity node) is deemed to be a parent entity node, and the subordinate entity node is deemed to be a child entity node. In this structured graph, any entity node (excepting the root entity node) has a single parent node but can have zero or more child entity nodes.

Typically, though not exclusively, an entity graph, such as entity graph 100, is utilized to manage and/or control a system or entity modeled by the entity graph, i.e., the modeled entity. A digital twin controller, as suggested above, typically executes one or more computer systems, and typically, primarily interacts with an entity graph via the root entity node and relationships to child entity nodes. In response to instructions from the digital twin controller, the root entity node may utilize information in an instruction that identifies the entity node within the entity graph, or may rely upon the various entity nodes to include sufficient processing capability to either process the request or pass it along to a subordinate entity node that is associated with an element of the modeled entity and that can process the request.

As will be noted in FIG. 1A, relationships between entity nodes are illustrated as arrows from one entity node to another, and are marked with a relationship pattern, Rxx λn, where “R” implies it's a relationship the “xy” identifies a source and target of the relationship (i.e., the directional flow of information), and where “λ” signifies a semantic context of the relationship and “n” identifies the specific context for the relationship, i.e., the basis or contextual meaning of the flow of information from source to target. For example, relationship Rab λ1 between entity node A 102 and entity node B 104 indicates a communication path from entity node A 102 to entity node B 104 based on semantic context “1”. As shown in FIG. 1A, in prior art digital twin implementations, a “return” communication from entity node B to entity node A constitutes a separate relationship, denoted as Rba λ1. As further shown in FIG. 1A, entity nodes A and B have communications based on two semantic contexts: 1 (λ1) and 6 (λ6). Prior art technology implements each communication direction (one direction only) between two nodes as a single relationship. Also, communications of differing semantic contexts result in separate relationships between two nodes.

As shown in FIG. 1A, this simple entity graph 100 must then maintain 4 separate relationships between entity node A and entity node B, as illustrated by box 154 in the relationship table 152 of FIG. 1B. Indeed, relationship table 150 enumerates each of the relationships of entity graph 100. As shown in relationship table 150, the simple entity graph 100 includes twelve relationships that are and must be maintained, including the non-paired relationships of box 154, denoted as Rce λ5 and Rce λ7 from entity node C 106 to entity node D 110 and having the semantic contexts, λ5 and λ7 in entity graph 100.

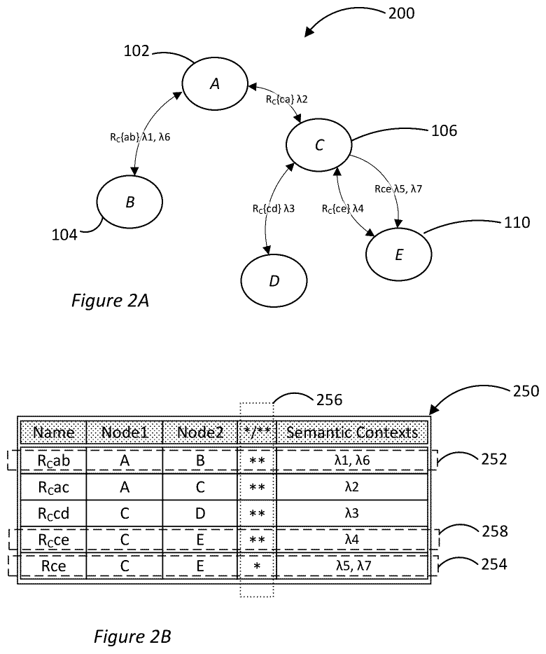

According to aspects of the disclosed subject matter, a digital twin modeled by an entity graph having bidirectional, multi-semantic relationships is presented. Advantageously, combining unidirectional but oppositely directed relationships among two entity nodes that share one or more common semantic contexts results in significant management/maintenance and storage savings. To better illustrate the advantages and details of multi-semantic bidirectional relationship, reference is made to the entity graph 200 of FIG. 2A.

FIG. 2A pictorial representation of the entity graph of FIG. 1 as adapted, according to aspects of the disclosed subject matter to include bidirectional and/or multi-semantic relationships among entity nodes. In continuance of the definitions above, it should be noted that “R_{C}” denotes a coalesced, bidirectional relationship, and the presence of “{xy}” denotes that the direction between the nodes is not important (i.e., bidirectional for each semantic context associated with the relationship).

Indeed, entity graph 200 comprises the same configuration of entity nodes as found in FIG. 1A, including entity nodes 102-110. Similarly, entity graph 200 logically supports the same relationships between these entity nodes as found in entity graph 100. However, in contrast to FIG. 1A and, especially the relationship table 150 of FIG. 1B, many of the relationships of FIG. 1A have been coalesced and replaced as bidirectional, multi-semantic relationships, resulting in greater processing and maintenance efficiency.

Advantageously, when relationship table 250 (FIG. 2B) is compared to relationship table 150 (FIG. 1B), one can see that the use of bidirectional and/or multi-semantic relationships reduces the number of stored and managed relationships. Indeed, just the relationships between entity nodes A and B are reduced from four managed relationships, as represented by box 152 of FIG. 1B, to a single managed relationship, as represented by box 252. Similarly, the 2 unidirectional relationships, Rce λ5 and Rce λ7, between entity nodes C 106 and D 110 are coalesced into a single relationship as illustrated in box 254. As will be appreciated by those in the art, often and especially when entity nodes model complex real-world systems (i.e., physical twins and their constituent elements), there may be dozens (or many more) of semantic contexts of communication between two entity nodes. Indeed, the disclosed novel utilization of bidirectional, multi-semantic relationships may be implemented to support any number of semantic contexts between two entity nodes.

Of course, to indicate the bidirectionality and multi-semantic nature of the relationships, the type of relationships as well as the various semantic contexts, are reflected in the relationship table, such as relationship table 250. Illustratively and without limitation, the nature of the relationships (bidirectional or unidirectional) is typically indicated, as shown by box 256. For example and with reference to FIGS. 2A and 2B, between entity node C 106 and entity node E 110, there is both a bidirectional relationship, R_{C}{ce} λ4, represented in the relationships table in box 258, and the unidirectional relationship, Rce λ5, λ7, represented in the relationship table in box 254. Of course, these two relationships, R_{C}{ce} λ4 and Rce λ5, λ7, cannot be coalesced due to their dissimilarity: a unidirectional relationship from entity node C 106 to entity node E 110, and a bidirectional relationship between entity node C and entity node E. This contrasts with the coalescing of the four unidirectional relationships between entity node A 102 and entity node B 104 from FIG. 1A to a single, bidirectional, multi-semantic relationship between the two entity nodes as shown in FIG. 2A, per box 252.

Regarding the unidirectional relationship, Rce λ5, λ7, from entity node C to entity node, and as represented in the relationship table in box 254, it should be appreciated that unidirectional, single semantic relationships may be found in an entity graph between entity nodes also having bidirectional and/or multi-semantic relationships. For example, by way of illustration and not limitation, assume that an entity graph includes a node for a warning horn controller an entity node for the warning horn. Assume, also, that the warning horn does not provide status, it simply receives a signal to emit a warning sound (presumably a hard-wired action by the warning horn) and responds. Further, for this exemplary situation, there is no return status. To accurately model such a relationship in an entity graph, a unidirectional, single semantic relationship is required and appropriate.

In accordance with additional aspects of the disclosed subject matter, there may be times that it is important for one or more elements of a digital twin may (as represented as entity nodes in the entity graph of the modeled system) wish to interact with external resources, i.e., services and/or systems that are external to the modeled system/physical twin. To create this “bridge” to one or more external resources, the notion of a virtual entity node is introduced.

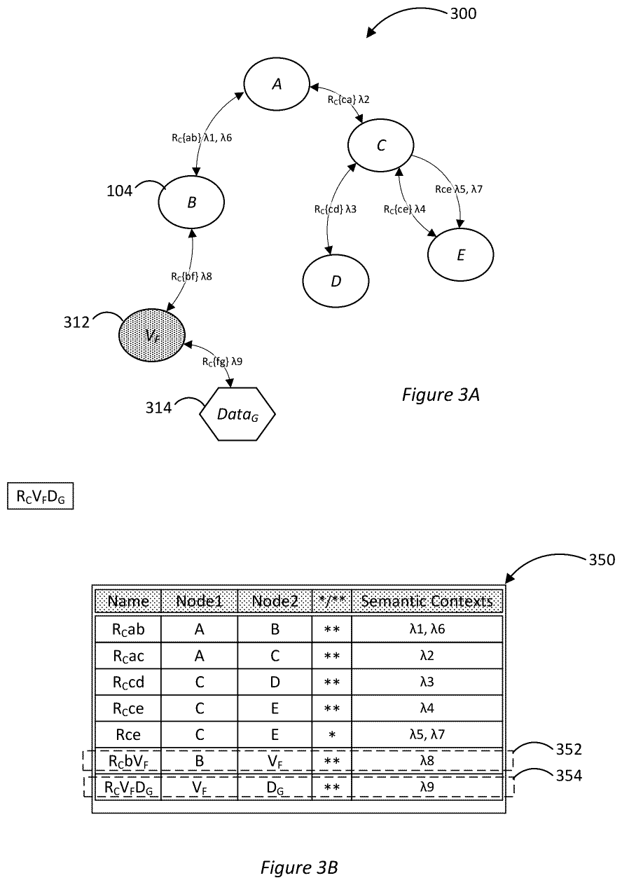

As suggested above, a virtual entity node incorporated into the entity graph of a digital twin serves as a bridge between the digital twin and an external resource (i.e., not part of the physical twin). In some embodiments and/or implementations, a virtual entity node may be viewed as a permanent element of a digital twin that bridges the digital twin to the external resource, and the relationship between an entity node of the entity graph and the virtual entity node is included in the relationship table of the digital twin. To this end, reference is made to FIGS. 3A and 3B.

FIG. 3A is a pictorial representation of an entity graph 300 that extends the entity graph 200 of FIG. 2A to include a virtual entity node for accessing an external resource. As can be seen, entity graph 300 includes a virtual entity node V_{F} 312 for interacting with an external resource, represented as data source Data_{G} 314. The relationship between virtual entity node V_{F} 312 and data source Data_{G} 314 is represented by the arrow in FIG. 3A and denoted as R_{C}{fg} λ9. It should be noted that in this illustrated entity graph 300, data source Data_{G} 314 is an external resource, i.e., it is not an entity of the entity graph and would not be located by a lookup action on the entity graph. In contrast, virtual entity node V_{F} 312 would be included as an entity of the entity graph and locatable via an entity lookup.

While external resources are not included in the entity graph, this does not preclude a digital twin controller (described more fully below) from maintaining information regarding the external resource, nor does it preclude the inclusion of relationship information between a virtual entity node and an external resource maintained in a relationship table. Indeed, FIG. 3B is a block diagram illustrating an exemplary relationship table 350 of relationships as found in the entity graph, such as the relationship 352 between entity node B 104 and virtual entity node V_{F} 312, and which further include the relationship 354 between virtual entity node V_{F} 312 and data source Data_{G} 314. Additionally, information gathered from external resources may be stored by one or more processed of a digital twin controller, as well as processed, analyzed, and utilized in making decisions on how to manage a digital twin. In short, while the origin of such captured data is from an external resource, the data can be stored and becomes “internal data” to the digital twin controller.

In this embodiment where this “bridge,” i.e., virtual node V_{F} 312 to data source Data_{G}314, is viewed as a more permanent feature, the relationships between the bridging entity node in the entity graph and the virtual entity node (i.e., between entity node B 104 and virtual node V_{F} 312 based on the relationship R_{C}{bf} λ8), as well as the bridging relationship between the virtual node and the data source (i.e., between virtual entity node V_{F} 312 and data source Data_{G} 314, based on the bidirectional, single semantic relationship R_{C}{fg} λ8), are reflected in relationship table 350 of the entity graph 300 of FIG. 3A, as illustrated by boxes 352 and 354.

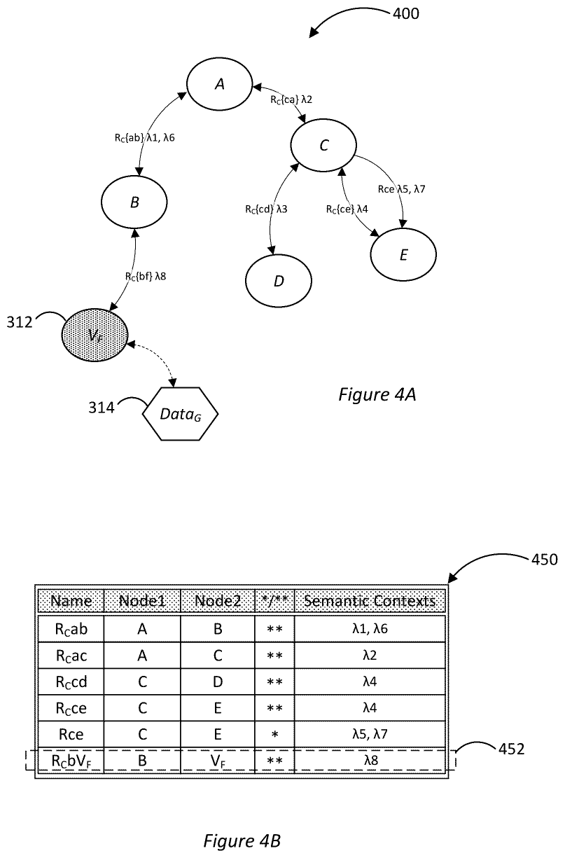

In alternative embodiments of the disclosed subject matter, bridging to external resources through virtual entity nodes is not required to be a permanent feature of a given entity graph and its corresponding relationship table. Turning to FIGS. 4A and 4B, FIG. 4A presents entity graph 400 that is a slight alternation from entity graph 300 in that the relationship between virtual entity node V_{F} 312 and data source Data_{G} 314, pictured with a dashed line, is, though not exclusively, implemented as an on-demand or just-in-time linkage. In alternative embodiments, these relationships may be implemented as permanent relationships (as shown in FIG. 3B). FIG. 4B is a block diagram illustrating an exemplary relationship table 450 of the entity graph 400 of FIG. 4A.

According to aspects of the disclosed subject matter, virtual node V_{F} 312 establishes a link to an external resource, e.g., the linkage between virtual entity node V_{F} 312 and data source Data_{G} 314, when that external service is requested or needed. In this situation, the linkage between a virtual entity node and an external resource may persist or not, but the relationship is established and maintained by the virtual entity node, shown in FIG. 3A as virtual entity node V_{F} 312. As shown in box 452 of the relationship table 450 of FIG. 4B, the relationships between entity node 104 and virtual entity node V_{F} 312 is included in the relationship table, while the relationship from virtual entity node V_{F} 312 to the external resource, data source Data_{G} 314, is not. In contrast to FIG. 3B, which lists the relationship between a virtual node and an external resource, and according to aspects of the disclosed subject matter, relationships with external resources may be included in a relationship table of a corresponding entity graph.

According to aspects of the disclosed subject matter, entity nodes are configured and/or encoded with information that permits them to be able to communicate with the corresponding element of the physical twin/modeled system. This configuration includes the ability to communicate, directly or indirectly though one or more networks, with the corresponding physical element. For example, assume that an entity node, called entity node X, corresponds to a temperature sensor in a room of a modeled building, i.e., the physical twin. When requested through the entity graph by the digital twin controller, entity node X may, if necessary, interact (via one or more application programming interface (API) calls, or one or more communication stack calls, and the like) with the temperature sensor and obtain the data representing the temperature of the room. In a similar manner, each entity node, as well as each virtual entity node, is configured to interact with their parent and child (if any) entity nodes in the entity graph, and to interact with a corresponding modeled “thing,” be it a structure, a feature, a data source, a service, and the like. Communication with the corresponding “thing” is made through unidirectional or bidirectional relationships based on one or more known semantic contexts.

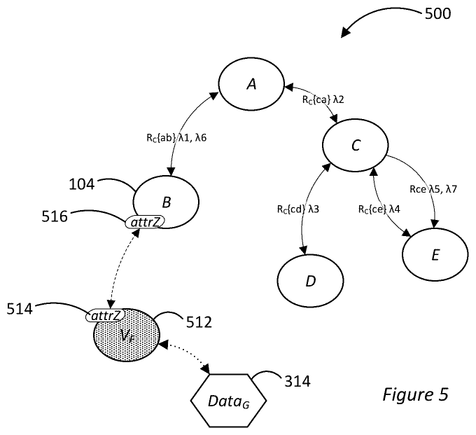

As a variation on the use of virtual entity nodes to access external resources, reference is now made to FIG. 5. FIG. 5 is a pictorial diagram of an entity graph 500 adapted from entity graph 400 of FIG. 4A, where access to an external resource is driven based on a desired attribute of that resource. In FIG. 5, entity node B 104 includes or is associated with an attribute module, attrZ 516. In various embodiments, an attribute module is configured to be able to communicate with a virtual entity node encoded with a corresponding attribute module, such as virtual entity node V_{F} 512 with attribute module 514. Additionally, the particular encoded virtual entity node is further configured to interact with an external resource, such as data source Data_{G} 314.

When a request is made for interaction with an external resource based on a desired attribute, an entity node configured to interact with an external resource having the desired attribute is identified. As illustrated in FIG. 5, this identified entity node is entity node B 104, having attribute module attrZ 516. Additionally, a virtual entity node configured with a corresponding attribute model suitable for interacting with an external resource having the desired attribute is allocated and linked into the entity graph, particularly with the identified entity. As shown in FIG. 5, virtual entity node V_{F} 512, having attribute module attrZ 514, is linked to the entity graph 500 through entity node B 104, and virtual entity node V_{F} is further configured to communicate with external data source Data_{G} 314. According to aspects of the disclosed subject matter, allocation of virtual entity node V_{F} 512 is made in an on-demand, just-in-time manner. As suggested by the dashed relationship lines between entity node B, the virtual entity node V_{F}, and the external data source Data_{G}, these relationships, while they may be bidirectional and/or multi-semantic, are typically considered temporary and not necessarily recorded in the relationship table for the modeled system.

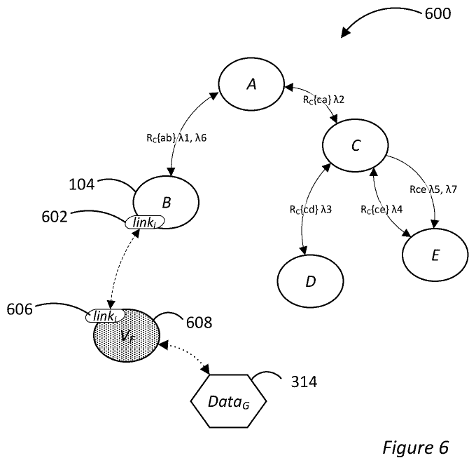

Turning to FIG. 6, FIG. 6 is a pictorial diagram of an entity graph 600 adapted from the entity graph 400 of FIG. 4A, where access to the external resource is driven based on link to an external resource, in accordance with aspects of the disclosed subject matter. In FIG. 6, entity node B 104 includes or is associated with a link module, denoted as link_{L} 602. In various embodiments, a link module in an entity node of the entity graph is configured to be able to communicate with a virtual entity node encoded with a corresponding link module, such as virtual entity node 608 with link module link_{L} 606. Additionally, the particular encoded virtual entity node is further configured to interact with an external resource as identified by a link, such as data source Data_{G} 314.

In a similar manner to access via attribute, when a request is made for interaction with an external resource identified by a link, an entity node configured to interact with an external resource via a link module is identified. As illustrated in FIG. 6, this identified entity node is entity node B 104 due, in part, to its configuration with link module, link_{L} 602. Additionally, a virtual entity node configured with a corresponding link model, link_{L} 606 suitable for interacting with an external resource having the desired attribute is allocated and linked into the entity graph, particularly with the identified entity. As shown in FIG. 6, virtual entity node V_{F} 608, having link module link_{L} 606, is linked to the entity graph 600 through entity node B 104, and virtual entity node V_{F} 608 is further configured to communicate with external data source Data_{G} 314. According to aspects of the disclosed subject matter, allocation of virtual entity node V_{F} 608 is made in an on-demand, just-in-time manner. As suggested by the dashed relationship lines between entity node B, the virtual entity node V_{F}, and the external data source Data_{G}, these relationships, while they may be bidirectional and/or multi-semantic, are typically viewed as temporary and not necessarily recorded in the relationship table for the modeled system.

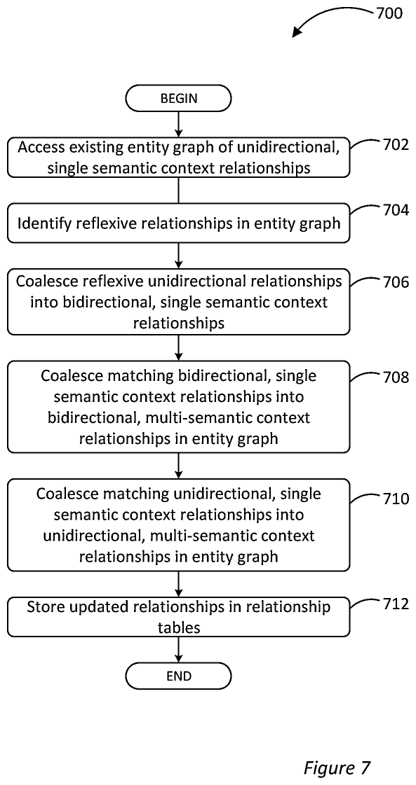

FIG. 7 is a flow diagram illustrating an exemplary routine 700 for converting an entity graph of a digital twin, comprising only unidirectional, single semantic context relationships, into an entity graph comprising bi-directional and/or multi-semantic relationships between entity nodes in the entity graph, all in accordance with aspects of the disclosed subject matter. Beginning at block 702, access to an existing entity graph is made, where the existing entity graph consists of unidirectional relationships having a single semantic context for a relationship. Entity graph 100 of FIG. 1A is illustrative of the type of entity graph to which routine 700 is applicable.

At block 704, reflexive relationships (meaning that a pair of relationships between the same two entity nodes but in different directions and having the same semantic context) are identified. For example and with reference to FIG. 1A, relationships Rab λ6 and Rba λ6, are reflexive relationships: they are between the same two entities, entity node A 102 and entity node B 104, but in different directions, and share the same semantic context, λ6.

At block 706, the reflexive relationships are coalesced into a single, bidirectional relationship having the semantic context of the pair of unidirectional reflexive relationships. Continuing the example above, the unidirectional reflexive relationships Rab λ6 and Rba λ6 are coalesced into a single bidirectional relationship having a single semantic context, R_{C}ab λ6.

At block 708, an additional coalescing may occur with respect to matching relationships. By matching it is meant that bidirectional relationships between the same two entities (they will have differing semantic contexts at this point) are coalesced such that the various semantic contexts are combined into a single bidirectional, multi-semantic relationship. With respect to the example above, after coalescing relationships Rab λ6 and Rba λ6 into R_{C}ab λ6, and after coalescing relationships Rab λ1 and Rba λ1 into R_{C}ab 1, relationships R_{C}ab λ6 and R_{C}ab λ1 are coalesced into relationship R_{C}ab λ1, λ6, as shown in FIG. 2B, box 252.

In some instances, relationships from one entity node to another may include two non-reflexive relationships with distinct semantic contexts. For example and in continuance of the example above, the two unidirectional relationships from entity node C 106 to entity node E 110, have distinct semantic contexts. At block 710 and according to aspects of the disclosed subject matter, matching (same entity nodes, same direction), coalesced into a single, unidirectional relationship having multiple semantic contexts. In continuance of the example relationships Rce λ5 and Rce λ7 are coalesce into relationship Rce λ5, λ7, as reflected in box 254 of relationship table 250 of FIG. 2B.

At block 712, after coalescing the relationships into bidirectional and/or multi-semantic contexts, where possible, the relationships are stored in the relationship table associated with (or as a part of) the entity graph. Thereafter, the routine 700 terminates.

Regarding the coalescing of relationships of an entity graph, and in accordance with aspects of the disclosed subject matter, in various circumstances it may be important, even advantageous, for the operators of the digital twin controller to maintain one or more reflexive pairs of unidirectional relationships, rather than coalescing them into bidirectional relationships. Similar considerations may be applied to reflexive pairs of single semantic relationships: maintained as a pair of relationships which share the same semantic context. Further still, in some contexts, as may be determined according to one configuring the entity graph. For example, assume two entity nodes, N and M. Assume also that there are at least a pair of reflexive unidirectional relationships. In some implementation contexts, it may be useful to coalesce one pair of unidirectional relationships and leave the other as a pair of unidirectional relationships. Moreover, similar considerations may be applied when considering whether to coalesce relationships based on semantic contexts.

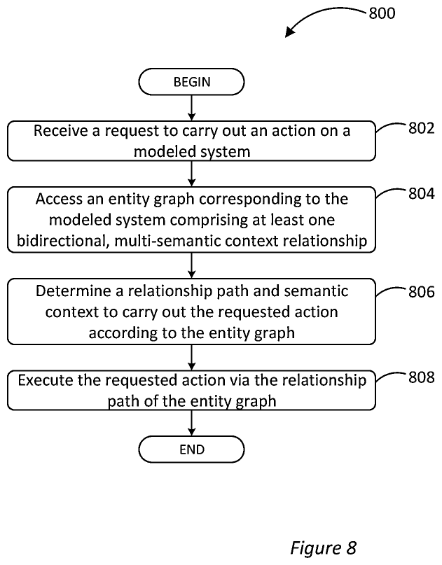

FIG. 8 is a flow diagram illustrating an exemplary routine 800 for executing an action on an element of a modeled system through a digital twin's entity graph of that modeled system. Beginning at block 802, a request for carrying out an action by a digital twin controller on a modeled system is received. Typically, though not exclusively, this request is made at the direction of a person—referred to as a user of a computer-executable digital twin controller application or suite of applications.

At block 804, an entity graph corresponding to the modeled system/physical twin comprising at least one bidirectional and/or multi-semantic context relationship is accessed. At block 806, a relationship path and semantic context within the entity graph of the modeled system is determined to carry out the requested action, where the relationship path leads to an entity node corresponding to an element of the modeled system suitable for implementing the requested action.

At block 806, the requested action is carried out on the entity graph, particularly with respect to the entity node in the entity graph that corresponds to an element of the modeled system where the action is directed. Thereafter, the routine 800 terminates.

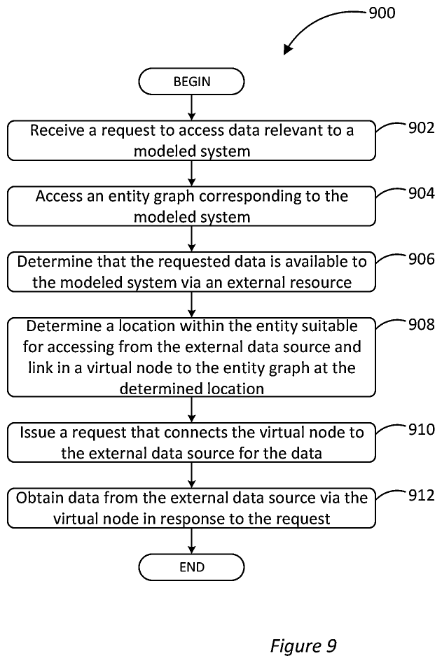

FIG. 9 is a flow diagram illustrating an exemplary routine 900 for accessing a data source external to a modeled system via a virtual entity graph node, all in accordance with aspects of the disclosed subject matter. This corresponds to the discussion above with respect to FIGS. 4A and 4B.

Beginning at block 902, a request for carrying out an action on the modeled system is received. Typically, though not exclusively, this request is made by a person—referred to as a user—of a computer-executable digital twin controller application or suite of applications.

At block 904, an entity graph corresponding to the modeled system comprising at least one bidirectional and/or one multi-semantic context relationship is accessed. At block 906, a determination that the request to the external resource can be made via a virtual entity node. At block 908, a relationship path and semantic context within the entity graph of the modeled system is determined to carry out the requested action, where the relationship path leads to a need for a virtual entity node that can bridge the request to a data source external to the modeled system. Additionally, a virtual entity node is allocated (if not previously allocated) for this external resource access. At block 910 the virtual entity node is linked into the entity graph, where the virtual entity node is configured to communicate with peers in the entity graph and further configured to interact with the external resource to carry out the requested action.

At block 912, the requested action is carried out on the entity graph, particularly utilizing the virtual entity node interacting with the external resource. Data, that may be obtained from the external resource, is returned back to the digital twin controller with the path that the request came. Thereafter, the routine 900 terminates.

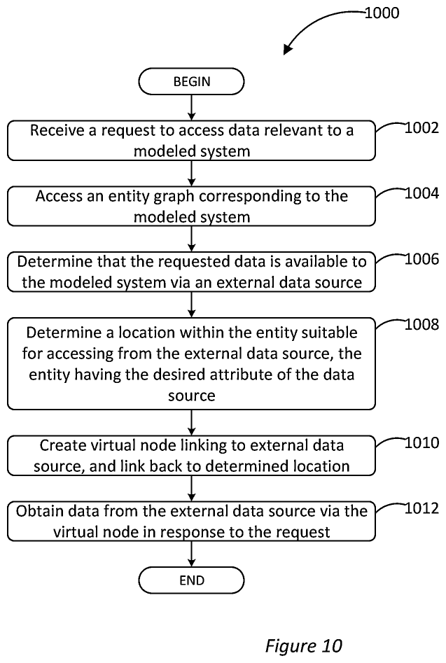

FIG. 10 is a flow diagram illustrating an exemplary routine 1000 for accessing an external resource to a modeled system using one or more attributes, in accordance with aspects of the disclosed subject matter. This corresponds to the discussion above with respect to FIG. 5. Beginning at block 1002, a request for carrying out an action on the modeled system is received at a digital twin controller. Typically, though not exclusively, this request is made by a person—referred to as a user—of the computer-executable digital twin controller application or suite of applications.

At block 1004, an entity graph corresponding to the modeled system upon which the request is made is accessed, where the entity graph comprises at least one bidirectional and/or a multi-semantic context relationship. At block 1006, a determination is made that the request to the external resource can be accomplished via a virtual entity node. At block 1008, a location, i.e., an entity node within the entity graph having a desired attribute in common with the external resource is identified. This node, referred to as the target node, is identified as configured an attribute module suitable for communicating with a virtual entity node that is similarly configured.

At block 1010, if a virtual entity node having an attribute module is not already linked to the target entity node, a virtual entity node having an attribute module corresponding to the desired attribute is allocated. This allocated virtual entity node is the bridge or link between the entity graph and the external data source. At block 1012, the requested action is carried out on the entity graph via, at least, the target entity node and the virtual entity node to the external resource. While not shown in FIG. 10, data that may be returned follows the path backward to the digital twin controller to provide that data. Thereafter, routine 1000 terminates.

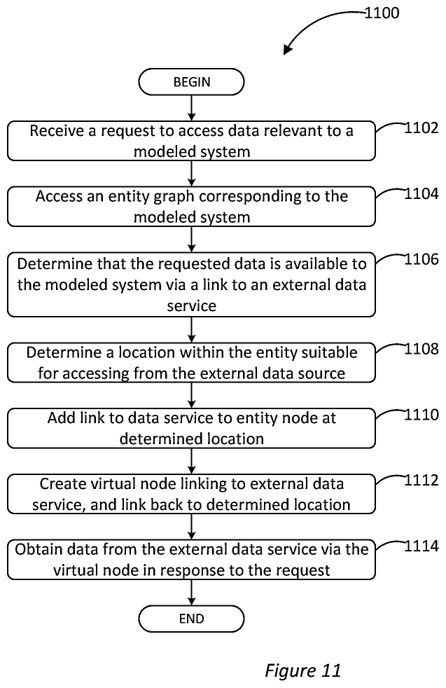

In a similar fashion to FIG. 10, FIG. 11 is a flow diagram illustrating an exemplary routine for accessing an external resource to a modeled system through the use of a link to that reservice, all in accordance with aspects of the disclosed subject matter. This corresponds to the discussion above with respect to FIG. 6. Beginning at block 1102, request for carrying out an action on the modeled system is received at a digital twin controller. Typically, though not exclusively, this request is made by a person—referred to as a user—of a computer-executable digital twin controller application or suite of applications.

At block 1104, an entity graph is accessed, the entity graph corresponding to the physical twin/modeled system upon which the request is made, and where the entity graph comprises at least one bidirectional and/or one multi-semantic context relationship. At block 1106, a determination that the request to the external resource can be made via a virtual entity node. This may entail looking up information regarding a link to the desired external resource in a data store associated with the computer-executable digital twin controller. At block 1108, a target entity node within the entity graph that is configured with the ability to communicate with an external resource via a link is identified. This target entity node includes a link module that is configured to communicate with a similarly configured virtual entity node for purposes of accessing the external resource.

At block 1110, if a suitably virtual entity node is not already linked to the identified entity node, the virtual entity node is allocated, the virtual entity node includes a link module to communicate with the external resource via an identified link. Further, the virtual entity node is linked to the target entity node, with the target entity node being its parent. This allocated virtual entity node is the bridge or link between the entity graph and the external resource. At block 1112, the request action is carried out on the entity graph via the virtual entity node to the external resource. While not shown in FIG. 11, data that may be returned follows the path backward to the digital twin controller to provide that data. Thereafter, routine 1100 terminates.

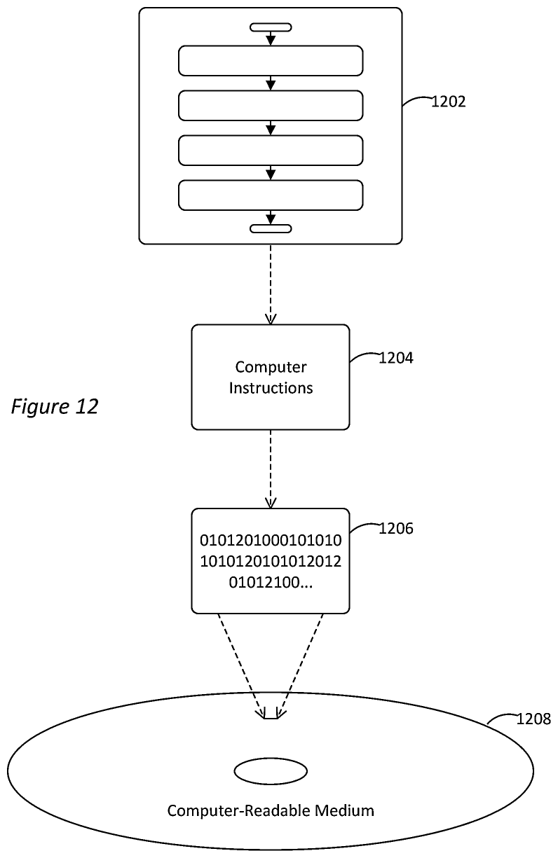

Turning now to FIG. 12, this figure presents a block diagram illustrating an exemplary logical arrangement of computer-readable medium that bears computer executable instructions for carrying out one or more aspects of the disclosed subject matter.

As will be appreciated by those skilled in the art, the logical organization comprises computer-readable medium 1208 on which is encoded computer-readable data 1206. While FIG. 12 illustrates an exemplary optical disc (e.g., a CD-R, DVD-R or a platter of a hard disk drive), non-limiting examples of a computer-readable medium (or media) include optical media (e.g., compact discs, “CDs”, in various writable and/or non-writable forms, digital versatile discs, “DVDs” in their various writeable and/or non-writable forms, etc.), solid-state memory devices (e.g., USB “thumb” drives, flash memory cards or devices, etc.), magnetic discs and magnetic tapes, read-only cartridge devices, magnetic fixed-disc hard drives, and the like. While computer-readable medium may be both transitory and non-transitory with respect to data storage, for purposes of the disclosed subject matter and unless specifically stated otherwise, computer-readable medium (or computer-readable media) should be interpreted as being non-transitory, i.e., stores data in a non-transitory manner. Of course, transitory memory refers to the fact that the data (and/or instructions) is stored only so long as power is supplied to the memory, whereas non-transitory memory is about to persist in storing data (and/or instructions) if when power is not supplied to the memory.

The computer-readable data 1206, in turn, correspond to computer-executable instructions and data 1204 that, when executed by a processor of a computer, operate according to one or more of the embodiments to implement a digital twin controller and/or a digital twin of a modeled system embodied in an entity graph, where the entity graph has least one bidirectional relationship between at least two entity notes, and/or has at least one multi-semantic relationship between two entity nodes of an entity graph.

The computer-executable instructions 1204 may be configured to perform one or more methods and/or routines, such as exemplary methods 700, 800, 900, 1000, and 1100, for example and without limitation. In another such embodiment, the computer-executable instructions 1204 may be configured to implement logical elements of a computing system, such as at least some of the exemplary computing system 1300, as described below that carry out the functions of a digital twin controller, including the management of an entity graph of a modeled system. The logical steps and/or computer-executable instructions are indicated by the logical elements 1202.

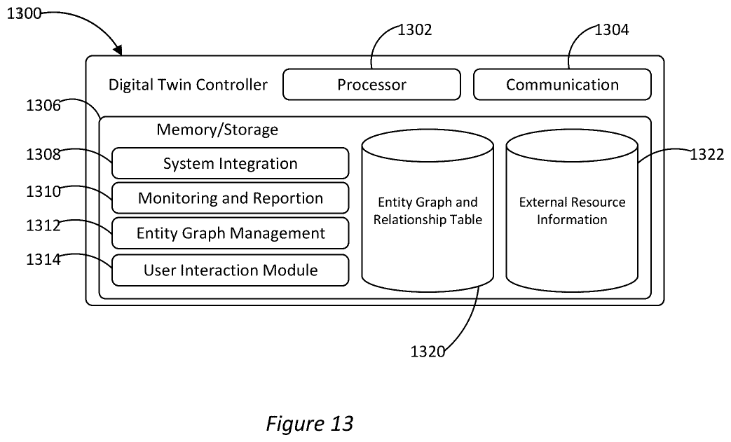

Turning now to FIG. 13, this figure illustrates a block diagram of exemplary, logical components of a digital twin controller 1300 implemented by and on a computer system, all in accordance with aspects of the disclosed subject matter.

Suitable computer systems include, by way of illustration and not limitation, desktop and laptop computers, tablet computer systems, handheld mobile computing devices, online computing platforms (often referred to as cloud computing services), distributed computing devices/computers, and the link. A suitable computer system, as illustrated in FIG. 13, will include a processor 1302 and memory and/or storage 1306, as well as other components that carry out various features of a computer/computing service.

Included is a communication component 1304 that comprises the necessary hardware and software to communicate with other devices and/or computers to carry out the various functions of the digital twin controller. This communication may be made over a wired connection (including metallic and optical connections), a wireless connection, or a combination of the two. Indeed, communication between entity nodes and corresponding elements of a modeled system are carried out through one or more communication components, such as communication component 1304 in conjunction with a system integration component 1308.

The system interface layer includes the hardware and software to for a communication stack with the various elements of the modeled system so that the entity nodes, at the direction of the digital twin controller (which is typically at the direction of a user of the digital twin controller system), can inter-communicate in the course of managing the digital twin/modeled system.

Regarding the memory/storage 1306, this includes both transitory memory used by the computer system to hold and execute commands, make calculations, and store data, as well as long term memory or storage where data is stored in a non-transitory manner.

The memory/storage 1306 includes various components (logical and actual) to carry out aspects of a digital twin controller. As shown in FIG. 13, these include the system integration component 1308, a monitoring and reporting component 1310, an entity graph management component 1312, a user interface module 1314, an entity graph and relationship table data store 1320 for storing information of one or more entity graphs, and an external resource information data store 1322 for storing aspects of external resources, including attributes and link information. For completeness and illustration, the digital twin controller, via various components including the system integration that enables access to the modeled system and its elements.

As suggested above, the system integration component 1308 provides the necessary integration aspects between entity nodes and their corresponding elements of a digital twin modeled system. Entity nodes are encoded with the ability to interact, via the system integration component, with the corresponding elements of the modeled system.

The monitoring and reporting component 1310 provides services for monitoring various aspects of the modeled system via one or more entity nodes and creates reportable information on the same. The entity graph management component 1312 maintains and manages the entity graph. Coalescing unidirectional relationships into bidirectional and/or multi-semantic relationships are carried by the entity graph management component. The user interface module 1314 provides a convenient interface to a digital twin modeled by the digital twin controller 1300.

An entity graph storage data store 1302, that variously configured entity nodes of an entity graph, as well as relationship information, such as relationship tables, of the various entity nodes. The attribute and link information data store maintains information regarding data sources/stores/services that may be used to access these services, stores, and/or services that are external to a modeled system, either by attribute or by link.

1. A computer-implemented method for managing a modeled system via a digital twin of the modeled system, comprising:
receiving a first action to be performed on a target element of the modeled system;
accessing an entity graph of the digital twin of the modeled system, wherein the relationships between entity nodes in the entity graph consist of unidirectional, single semantic context relationships;
updating the entity graph by causing a coalescing of the unidirectional, single semantic context relationships of the entity graph, the coalescing resulting in the replacement of at least two unidirectional, single semantic context relationships with at least one of a bidirectional relationship or a multi-semantic relationship between two entity nodes of the entity graph;
storing the updated entity graph as the updated entity graph of the digital twin of the modeled system; and
causing the first action to be performed by a target entity node of the updated entity graph on the target element of the modeled system, the target entity corresponding to the target element of modeled system;
wherein causing the first action to be performed by the target entity node comprises traversal of the entity graph from a root entity node of the entity graph to the target entity node via at least one of a bidirectional relationship or a multi-semantic relationship between two entity nodes of the entity graph.

2. The computer-implemented method of claim 1, wherein traversal of the entity graph from a root entity node to the target entity node is made via at least one bidirectional, multi-semantic relationship.

3. The computer-implemented method of claim 1, wherein the target entity node is configured to interact with the corresponding element of the modeled system to carry out the first action.

4. The computer-implemented method of claim 3, wherein the target entity node interacts with the corresponding element of the modeled system indirectly over a computer network.

5. The computer-implemented method of claim 1, further comprising:
creating a first virtual entity node suitably configured to interact with an external data source that is not part of the modeled system; and
determining that the first action requires data from the external data source and, in response, obtaining external data from the external data source via the first virtual node entity;
wherein causing the first action to be performed by a target entity node of the updated entity graph on the target element of the modeled system comprises:
causing the first action to be performed by a target entity node on the target element of the modeled system in conjunction with the external data.

6. The computer-implemented method of claim 5, further comprising:
identifying a parent entity node in the entity graph as a parent entity node for the first virtual entity node;
storing first virtual entity node in the entity graph; and
storing a bidirectional relationship between the parent entity node and the first virtual entity node in a relationship table of the digital twin.

7. The computer-implemented method of claim 5, further comprising:
determining a first attribute associated with the external data source;
identifying a parent entity node in the entity graph as a parent entity node for the first virtual entity node, wherein the parent entity node is configured to associate with the first virtual entity node via an attribute component corresponding to the first attribute; and
wherein obtaining external data from the external data source via the first virtual node entity comprises requesting data via the attribute component of the parent entity node.

8. The computer-implemented method of claim 5, further comprising:
determining a link to the external data source;
identifying a parent entity node in the entity graph as a parent entity node for the first virtual entity node, wherein the parent entity node is configured to associate with the first virtual entity node via the link component of the parent entity node; and
wherein obtaining external data from the external data source via the first virtual node entity comprises requesting data via the parent entity node.

9. A computer-implemented method for managing a modeled system via a digital twin of the modeled system, comprising:
receiving an action to be performed for the modeled system;
accessing an entity graph of the digital twin of the modeled system, wherein the relationships between entity nodes in the entity graph comprise at least one or more of a bidirectional relationship or a multi-semantic context relationship between entity nodes of the entity graph;
determining that the received action requires the use of a service external to the modeled system;
identifying an external service suitable for use in completing the received action from an external resource data store;
creating a virtual entity node configured to interact with the external service and linking the virtual entity node to a parent entity node for the virtual entity node within the entity graph; and
causing the received action to be performed, at least in part, by the external service via interaction between the virtual entity node and the external service;
wherein causing the received action to be performed, at least in part, by the external service via interaction between the virtual entity node and the external service comprises traversal of the entity graph from a root entity node of the entity graph to the virtual entity node via at least one of a bidirectional relationship or a multi-semantic relationship between two entity nodes of the entity graph.

10. The method of claim 9, wherein traversal from the entity graph from the root entity node of the entity graph to the virtual entity node is made via at least one of a bidirectional, multi-semantic relationship between two entity nodes of the entity graph.

11. The method of claim 9, wherein the virtual entity node linked into entity graph from the parent entity node of the entity graph via a relationship between the virtual entity node and the parent entity node.

12. The method of claim 11, further comprising saving virtual node as an element of the entity graph, including saving the relationship between the patent entity node and virtual entity node in a relationship table of the digital twin.

13. The method of claim 9, further comprising:
determining a first attribute associated with the external service;
identifying the parent entity node in the entity graph according to the first attribute, wherein the parent entity node includes an attribute module configured to associated with the virtual entity node on the basis of the first attribute; and
wherein causing the received action to be performed, at least in part, by the external service via interaction between the virtual entity node and the external service comprises causing the received action to be performed via the attribute module of the parent entity node to cause the interaction between the virtual entity node and the external service.

14. The method of claim 9, further comprising:
determining a first attribute associated with the external service;
identifying the parent entity node in the entity graph according to the first attribute, wherein the parent entity node includes an attribute module configured to associated with the virtual entity node on the basis of the first attribute; and
wherein causing the received action to be performed, at least in part, by the external service via interaction between the virtual entity node and the external service comprises causing the received action to be performed via the attribute module of the parent entity node to cause the interaction between the virtual entity node and the external service.

15. A computer system configured to implement a digital twin controller for managing a system modeled by a digital twin, the computer system comprising:
a processor that executes computer-executable components of the digital twin, each executable component comprising at least computer-executable instructions; and
a memory that stores computer executable instructions and computer-readable data for implementing the digital twin controller of the computer system;
wherein the digital twin controller, in operation on the computer system, is configured to:
receive a first action to be performed for the modeled system;
accessing an entity graph of the digital twin of the modeled system, wherein the relationships between entity nodes in the entity graph comprise one or more bidirectional relationship between entity nodes of the entity graph;
identifying a target entity node of the entity graph that is suitably configured to carry out the first action on a corresponding element of the modeled system;
causing the first action to be performed via the target entity node on the element of the modeled system, the target entity corresponding to the element of modeled system;
wherein causing the first action to be performed by the target entity node comprises traversal of the entity graph from a root entity node of the entity graph to the target entity node via at least one of a bidirectional relationship between two entity nodes of the entity graph or a multi-semantic relationship between two entity nodes of the entity graph.

16. The computer system of claim 15, wherein the target entity node is configured to interact with the corresponding element of the modeled system to carry out the first action.

17. The computer system of claim 16, wherein the target entity node interacts with the corresponding element of the modeled system indirectly over a computer network.

18. The computer system of claim 16, wherein the digital twin controller, in operation on the computer system, is further configured to:
determine that the first action requires data from an external data service and, in response, create a first virtual entity node suitably configured to interact with the external data service, wherein the external data service is not part of the modeled system; and
obtain external data from the external data service via the first virtual node entity; and
causing the first action to be performed by the target entity node on the target element of the modeled system in conjunction with the external data.

19. The computer system of claim 18, wherein the digital twin controller, in operation on the computer system, is further configured to save the virtual node as an element of the entity graph, including saving the relationship between the target entity node and virtual entity node in a relationship table of the digital twin.
